(19) United States
(12) Patent Application Publication
(10) Pub. No.: US 2022/0386282 A1
(43) Pub. Date: Dec. 1, 2022

(54) COMMUNICATIONS DEVICE, INFRASTRUCTURE EQUIPMENT AND METHODS

(71) Applicant: Sony Group Corporation, Tokyo (JP)

(72) Inventors: Yassin Aden AWAD, Basingstoke (GB); Shin Horng WONG, Basingstoke (GB)

(73) Assignee: Sony Group Corporation, Tokyo (JP)

(21) Appl. No.: 17/771,493

(22) PCT Filed: Oct. 28, 2020
(86) PCT No.: PCT/EP2020/080332

§ 371 Date: Apr. 25, 2022

(30) Foreign Application Priority Data
Nov. 8, 2019 (EP) 19208190.9

(51) Int. Cl. H04W 72/04; H04W 72/02

(52) U.S. Cl. CPC H04W 72/042; H04W 72/0446; H04W 72/02; H04W 92/10

(57) ABSTRACT

A method of operating a communications device in a wireless communications network, the wireless communications network comprising infrastructure equipment providing a wireless access interface, the method comprising: receiving a downlink control information (DCI) message, the DCI message comprising a time domain indication of a start time and a duration of communications resources of the wireless access interface, and determining the start time and the duration of the allocated communications resources based on the time domain indication. The time domain indication comprising an indication a combined start and length indicator value (SLIV) calculated based on a symbol period number and a duration, and a slot offset, when the allocated communications resources are within a single time slot, and determining a start time by determining the symbol period number indicated by the SLIV value calculated using either a first rule or a second rule and the slot offset value.

### BACKGROUND

### Field

The present disclosure relates to communications devices, infrastructure equipment and methods for the allocation of communications resources in a wireless communications network.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

Third and fourth generation mobile telecommunication systems, such as those based on the 3GPP defined UMTS and Long Term Evolution (LTE) architecture, are able to support more sophisticated services than simple voice and messaging services offered by previous generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, may be expected to increase ever more rapidly.

Future wireless communications networks will be expected to support communications routinely and efficiently with a wider range of devices associated with a wider range of data traffic profiles and types than current systems are optimised to support. For example it is expected future wireless communications networks will be expected to efficiently support communications with devices including reduced complexity devices, machine type communication (MTC) devices, high resolution video displays, virtual reality headsets and so on. Some of these different types of devices may be deployed in very large numbers, for example low complexity devices for supporting the “The Internet of Things”, and may typically be associated with the transmissions of relatively small amounts of data with relatively high latency tolerance.

In view of this there is expected to be a desire for future wireless communications networks, for example those which may be referred to as 5G or new radio (NR) system/new radio access technology (RAT) systems [1], as well as future iterations/releases of existing systems, to efficiently support connectivity for a wide range of devices associated with different applications and different characteristic data traffic profiles.

An example of such a new service is referred to as Ultra Reliable Low Latency Communications (URLLC) services which, as its name suggests, requires that a data unit or packet be communicated with a high reliability and with a low communications delay. URLLC type services therefore represent a challenging example for both LTE type communications systems and 5G/NR communications systems.

The increasing use of different types of communications devices associated with different traffic profiles gives rise to new challenges for efficiently handling communications in wireless telecommunications systems that need to be addressed.

### SUMMARY

The present disclosure can help address or mitigate at least some of the issues discussed above.

Embodiments of the present technique can provide a method of operating a communications device in a wireless communications network, the wireless communications network comprising infrastructure equipment providing a wireless access interface. The method comprises receiving a downlink control information (DCI) message, the DCI message comprising a time domain indication of a start time and a duration of communications resources of the wireless access interface allocated for the transmission of data, the wireless access interface providing communications resources arranged in the time domain in time slots and symbol periods, each time slot comprising a plurality of symbol periods, and determining the start time and the duration of the allocated communications resources based on the time domain indication. The time domain indication comprises an indication of the value of each of one or more parameters, the one or more parameters comprising a combined start and length indicator value (SLIV) calculated based on a symbol period number and a duration, and a slot offset. When the allocated communications resources are within a single time slot, the SLIV value is calculated based on the symbol period number and the duration in accordance with a first rule, and when the allocated communications resources are not within a single time slot, the SLIV value is calculated based on the symbol period number and the duration in accordance with a second rule. Determining the start time comprises determining the symbol period number indicated by the SLIV value calculated using either the first rule or the second rule and the slot offset value.

Embodiments can therefore provide methods in which an increased flexibility of resource allocations is possible, in which a particular constraint may not be satisfied. Nevertheless, a technique for determining the SLIV value can re-use steps used to decode the SLIV value when it is calculated on the assumption that the particular constraint is required to be satisfied. Preferably, the particular constraint may be that the allocated resources are contained within a single time slot.

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and:

FIG. 1 schematically represents some aspects of an LTE-type wireless telecommunication system which may be configured to operate in accordance with certain embodiments of the present disclosure;

FIG. 2 schematically represents some aspects of a new radio access technology (RAT) wireless telecommunications system which may be configured to operate in accordance with certain embodiments of the present disclosure;

FIG. 3 is a schematic block diagram of an example infrastructure equipment and communications device which may be configured in accordance with example embodiments;

FIG. 4 illustrates a transmission of uplink data in accordance with conventional techniques;

FIG. 5 illustrates a process which may be carried out by a communications device in accordance with conventional techniques for deriving a start symbol period and a duration from a combined parameter;

FIG. 6 illustrates a transmission of uplink data in accordance with proposals to modify conventional techniques;

FIG. 7 shows a table of combined Start and length indicator value (SLIV) parameter values for corresponding S (start symbol period) and L (duration) parameter values, calculated according to conventional techniques;

FIG. 8 shows a table of combined SLIV parameter values for corresponding S (start symbol period) and L (duration) parameter values, calculated in accordance with embodiments of the present technique;

FIG. 9 illustrates a process which may be carried out by a communications device in accordance with embodiment of the present technique for deriving the start symbol period and the duration from a combined parameter; and

FIG. 10 is a combined process diagram and message sequence chart which illustrates an example of transmissions and processes in accordance with embodiments of the present technique.

### DETAILED DESCRIPTION OF THE EMBODIMENTS

### Long Term Evolution Advanced Radio Access Technology (4G)

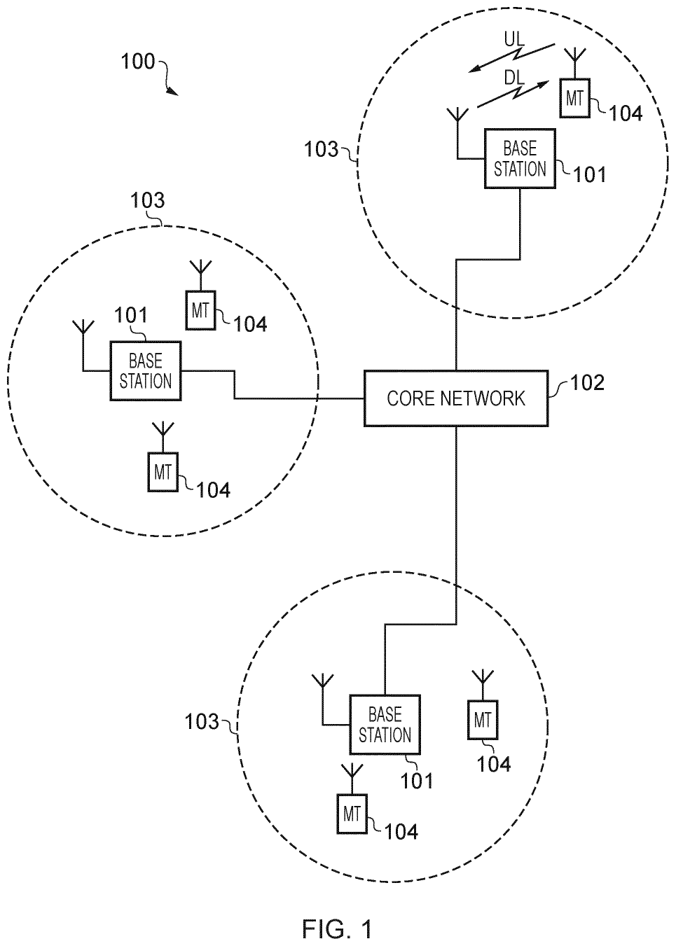

FIG. 1 provides a schematic diagram illustrating some basic functionality of a mobile telecommunications network/system 100 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP (RTM) body, and also described in many books on the subject, for example, Holma H. and Toskala A [2]. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 100 includes a plurality of base stations 101 connected to a core network part 102. Each base station provides a coverage area 103 (e.g. a cell) within which data can be communicated to and from communications devices 104. Data is transmitted from the base stations 101 to the communications devices 104 within their respective coverage areas 103 via a radio downlink. Data is transmitted from the communications devices 104 to the base stations 101 via a radio uplink. The core network part 102 routes data to and from the communications devices 104 via the respective base stations 101 and provides functions such as authentication, mobility management, charging and so on. Communications devices may also be referred to as mobile stations, user equipment (UE), user terminals, mobile radios, terminal devices, and so forth. Base stations, which are an example of network infrastructure equipment/network access nodes, may also be referred to as transceiver stations/nodeBs/e-nodeBs, g-nodeBs (gNB) and so forth. In this regard different terminology is often associated with different generations of wireless telecommunications systems for elements providing broadly comparable functionality. However, example embodiments of the disclosure may be equally implemented in different generations of wireless telecommunications systems such as 5G or new radio as explained below, and for simplicity certain terminology may be used regardless of the underlying network architecture. That is to say, the use of a specific term in relation to certain example implementations is not intended to indicate these implementations are limited to a certain generation of network that may be most associated with that particular terminology.

### New Radio Access Technology (5G)

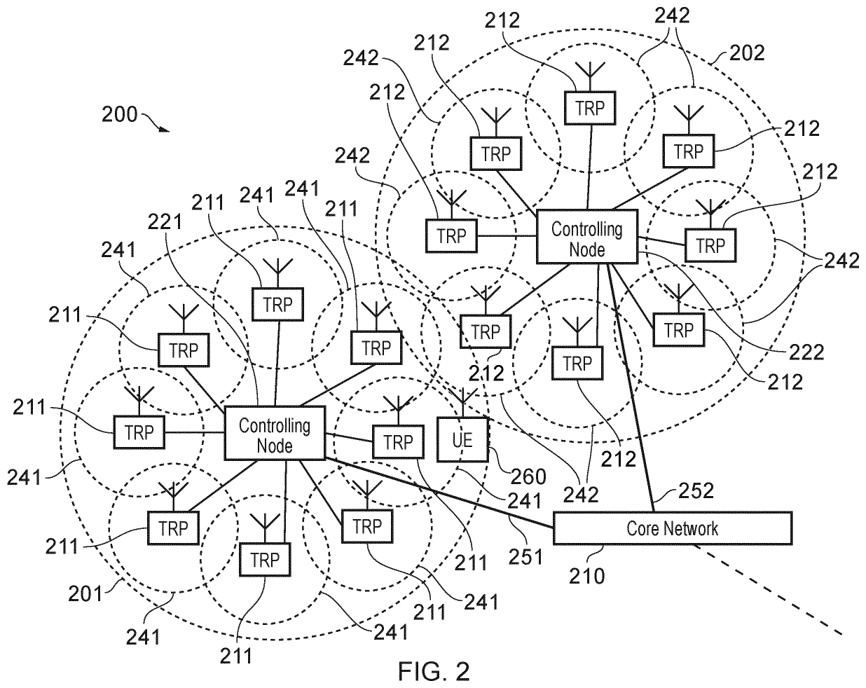

FIG. 2 is a schematic diagram illustrating a network architecture for a new RAT wireless communications network/system 200 based on previously proposed approaches which may also be adapted to provide functionality in accordance with embodiments of the disclosure described herein. The new RAT network 200 represented in FIG. 2 comprises a first communication cell 201 and a second communication cell 202. Each communication cell 201, 202, comprises a controlling node (centralised unit) 221, 222 in communication with a core network component 210 over a respective wired or wireless link 251, 252. The respective controlling nodes 221, 222 are also each in communication with a plurality of distributed units (radio access nodes/remote transmission and reception points (TRPs)) 211, 212 in their respective cells. Again, these communications may be over respective wired or wireless links. The distributed units 211, 212 are responsible for providing the radio access interface for communications devices connected to the network. Each distributed unit 211, 212 has a coverage area (radio access footprint) 241, 242 where the sum of the coverage areas of the distributed units under the control of a controlling node together define the coverage of the respective communication cells 201, 202. Each distributed unit 211, 212 includes transceiver circuitry for transmission and reception of wireless signals and processor circuitry configured to control the respective distributed units 211, 212.

In terms of broad top-level functionality, the core network component 210 of the new RAT communications network represented in FIG. 2 may be broadly considered to correspond with the core network 102 represented in FIG. 1, and the respective controlling nodes 221, 222 and their associated distributed units/TRPs 211, 212 may be broadly considered to provide functionality corresponding to the base stations 101 of FIG. 1. The term network infrastructure equipment/access node may be used to encompass these elements and more conventional base station type elements of wireless communications systems. Depending on the application at hand the responsibility for scheduling transmissions which are scheduled on the radio interface between the respective distributed units and the communications devices may lie with the controlling node/centralised unit and/or the distributed units/TRPs.

A communications device or UE 260 is represented in FIG. 2 within the coverage area of the first communication cell 201. This communications device 260 may thus exchange signalling with the first controlling node 221 in the first communication cell via one of the distributed units 211 associated with the first communication cell 201. In some cases communications for a given communications device are routed through only one of the distributed units, but it will be appreciated that in some other implementations communications associated with a given communications device may be routed through more than one distributed unit, for example in a soft handover scenario and other scenarios.

In the example of FIG. 2, two communication cells 201, 202 and one communications device 260 are shown for simplicity, but it will of course be appreciated that in practice the system may comprise a larger number of communication cells (each supported by a respective controlling node and plurality of distributed units) serving a larger number of communications devices.

It will further be appreciated that FIG. 2 represents merely one example of a proposed architecture for a new RAT communications system in which approaches in accordance with the principles described herein may be adopted, and the functionality disclosed herein may also be applied in respect of wireless communications systems having different architectures.

Thus example embodiments of the disclosure as discussed herein may be implemented in wireless telecommunication systems/networks according to various different architectures, such as the example architectures shown in FIGS. 1 and 2. It will thus be appreciated that the specific wireless communications architecture in any given implementation is not of primary significance to the principles described herein. In this regard, example embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 101 as shown in FIG. 1 which is adapted to provide functionality in accordance with the principles described herein, and in other examples the network infrastructure equipment/access node may comprise a control unit/controlling node 221, 222 and/or a TRP 211, 212 of the kind shown in FIG. 2 which is adapted to provide functionality in accordance with the principles described herein.

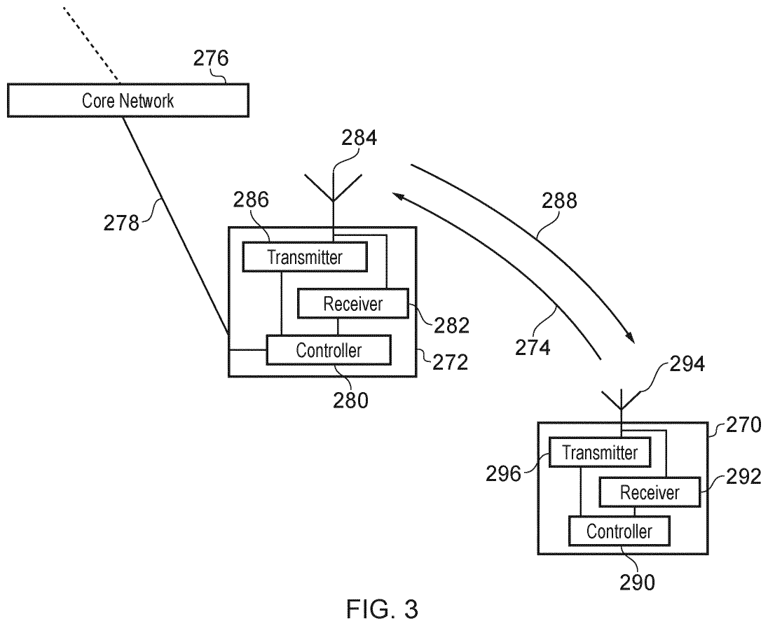

A more detailed illustration of a UE/communications device 270 (which may correspond to a communications device such as the communications device 260 of FIG. 2 or the communications device 104 of FIG. 1) and an example network infrastructure equipment 272, which may be thought of as a gNB 101 or a combination of a controlling node 221 and TRP 211, is presented in FIG. 3. As shown in FIG. 3, the UE 270 is shown to transmit uplink data to the infrastructure equipment 272 via uplink resources of a wireless access interface as illustrated generally by an arrow 274 from the UE 270 to the infrastructure equipment 272. The UE 270 may similarly be configured to receive downlink data transmitted by the infrastructure equipment 272 via downlink resources as indicated by an arrow 288 from the infrastructure equipment 272 to the UE 270. As with FIGS. 1 and 2, the infrastructure equipment 272 is connected to a core network 276 via an interface 278 to a controller 280 of the infrastructure equipment 272. The infrastructure equipment 272 includes a receiver 282 connected to an antenna 284 and a transmitter 286 connected to the antenna 284. Correspondingly, the UE 270 includes a controller 290 connected to a receiver 292 which receives signals from an antenna 294 and a transmitter 296 also connected to the antenna 294.

The controller 280 is configured to control the infrastructure equipment 272 and may comprise processor circuitry which may in turn comprise various sub-units/sub-circuits for providing functionality as explained further herein. These sub-units may be implemented as discrete hardware elements or as appropriately configured functions of the processor circuitry. Thus the controller 280 may comprise circuitry which is suitably configured/programmed to provide the desired functionality using conventional programming/configuration techniques for equipment in wireless telecommunications systems. The transmitter 286 and the receiver 282 may comprise signal processing and radio frequency filters, amplifiers and circuitry in accordance with conventional arrangements. The transmitter 286, the receiver 282 and the controller 280 are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment 272 will in general comprise various other elements associated with its operating functionality.

Correspondingly, the controller 290 of the UE 270 is configured to control the transmitter 296 and the receiver 292 and may comprise processor circuitry which may in turn comprise various sub-units/sub-circuits for providing functionality as explained further herein. These sub-units may be implemented as discrete hardware elements or as appropriately configured functions of the processor circuitry. Thus the controller 290 may comprise circuitry which is suitably configured/programmed to provide the desired functionality using conventional programming/configuration techniques for equipment in wireless telecommunications systems. Likewise, the transmitter 296 and the receiver 292 may comprise signal processing and radio frequency filters, amplifiers and circuitry in accordance with conventional arrangements. The transmitter 296, receiver 292 and controller 290 are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the communications device 270 will in general comprise various other elements associated with its operating functionality, for example a power source, user interface, and so forth, but these are not shown in FIG. 3 in the interests of simplicity.

The controllers 280, 290 may be configured to carry out instructions which are stored on a computer readable medium, such as a non-volatile memory. The processing steps described herein may be carried out by, for example, a microprocessor in conjunction with a random access memory, operating according to instructions stored on a computer readable medium.

5G, URLLC and Industrial Internet of Things

Systems incorporating NR technology are expected to support different services (or types of services), which may be characterised by different requirements for latency, data rate and/or reliability. For example, Enhanced Mobile Broadband (eMBB) services are characterised by high capacity with a requirement to support up to 20 Gb/s. The requirements for Ultra Reliable & Low Latency Communications (URLLC) services are for a reliability of 1-10⁻⁵ (99.999%) or higher for one transmission of a 32 byte packet with a user plane latency of 1 ms [3]. In some scenarios, there may be a requirement for a reliability of 1-10⁻⁶ (99.9999%) or higher with either 0.5 ms or 1 ms of user plane latency. Massive Machine Type Communications (mMTC) is another example of a service which may be supported by NR-based communications networks.

In addition, systems may be expected to support further enhancements related to Industrial Internet of Things (IIoT) in order to support services with new requirements of high availability, high reliability, low latency, and in some cases, high-accuracy positioning.

Industrial automation, energy power distribution and intelligent transport systems are examples of new use cases for Industrial Internet of Things (IIoT). In an example of industrial automation, the system may involve different distributed components working together. These components may include sensors, virtualized hardware controllers and autonomous robots, which may be capable of initiating actions or reacting to critical events occurring within a factory and communicating over a local area network.

The UEs in the network may therefore be expected to handle a mixture of different traffic, for example, associated with different applications and potentially different quality of service requirements (such as maximum latency, reliability, packet sizes, throughput). Some messages for transmission may be time sensitive and be associated with strict deadlines and the communications network may therefore be required to provide time sensitive networking (TSN) [6].

URLLC services are required in order to meet the requirements for IIoT, which require high availability, high reliability, low latency, and in some cases, high-accuracy positioning [1]. Some IIoT services may be implemented by using a mixture of eMBB and URLLC techniques, where some data is transmitted by eMBB and other data is transmitted by URLLC.

### Downlink Control Information

In 5G/NR, communications resources for both uplink and downlink communications are allocated by the infrastructure equipment, and may be signalled to the communications device in downlink control information (DCI), transmitted using a physical downlink control channel (PDCCH).

Each communications device may be configured with a specific search space within which the PDCCH may exist, the search space defining communications resources (and, optionally, other parameters) with which DCI allocating communications resources to that communications device may be transmitted.

### Communications Resources for Uplink Data

Uplink data transmitted by a communications device may be transmitted using a Physical Uplink Shared Channel (PUSCH). The PUSCH can be dynamically scheduled by the infrastructure equipment in an Uplink (UL) Grant. The uplink grant may be a dynamic grant or a configured grant. A dynamic grant provides a single instance of allocated communications resources and is indicated by means of scheduling information contained in a DCI. A configured grant may be a semi-static configuration comprising a sequence of instances of allocated communications resources.

A DCI indicating a dynamic grant comprises a Time Domain Resource Assignment (TDRA) field, which indicate the time resources of the PUSCH. The TDRA field may comprise an indication of an index or row of a TDRA Table. The TDRA Table may be predetermined, for example by means of specification in an appropriate standard, or by configuration of the communications device by infrastructure equipment of the wireless communications network (e.g. by means of RRC Reconfiguration).

Each entry/row in the TDRA Table may specify a slot gap parameter K₂, a start symbol offset S (relative to the slot boundary) and a duration L (in OFDM symbol periods) of the PUSCH resources. The minimum value of S may be zero, indicating that the uplink communications resources begin at the start of the first (i.e. 0'th) symbol of the slot. The minimum value of L may be one, i.e. the minimum duration of the allocated resources may be one symbol period.

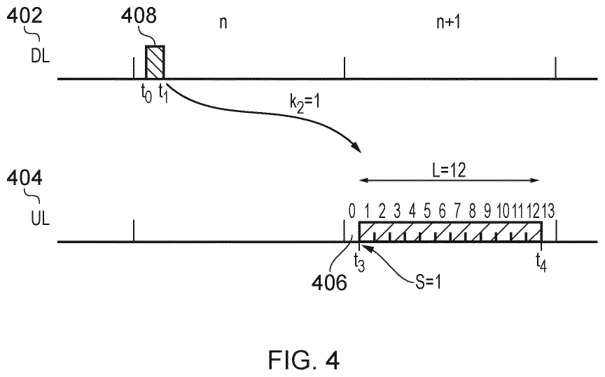

FIG. 4 illustrates a transmission of uplink data in accordance with conventional techniques. FIG. 4 illustrates an example of a use of the K₂, S and L parameters for a PUSCH.

FIGS. 4 shows downlink communications resources 402 of a wireless access interface of a wireless communications network and uplink communications resources 404 of the wireless access interface. The communications resources are divided into timeslots n, n+1, n+2, each of which is further subdivided into 14 orthogonal frequency division multiplexing (OFDM) symbol periods 406.

A UL grant is transmitted within a PDCCH transmission 408 from time t0 to time t1 within timeslot n. The UL Grant comprises a TDRA index which points to an entry in the TDRA Table which indicates parameters K₂=1, S=1 and L=12. Since the UL Grant is transmitted in Slot n, the allocated PUSCH resources therefore start in slot n+K2, i.e. slot n+1. The symbol offset from the slot boundary of slot n+1 is indicated by the parameter S, which in this case is 1 symbol from the slot boundary. Accordingly, the start time of the PUSCH is at time t3 (1 symbol from the start of timeslot n+1). The duration of the allocated PUSCH resources is L=12 symbols. Hence, the TDRA parameters indicate a PUSCH transmission between time t3 and time t4 as shown in FIG. 4. The entries in the TDRA table may be semi-statically configured by radio resource configuration (RRC) and the size of the table may in some examples be limited to 16 entries.

### SLIV Values

Conventionally, such as in 3GPP Release 15 for NR, each instance of dynamically allocated uplink communication resources has been constrained to be within one timeslot. That is, allocations of resources which extend from one time slot to a next time slot are not permitted. This corresponds to a joint constraint on the values of L and S. Specifically, the sum of L and S cannot exceed 14. This constraint has conventionally been exploited to efficiently jointly encode the values of L and S within a start and length indicator value (SLIV), according to equation (1) as follows:

if (L−1)≤7 then (1)

SLIV=14·(L−1)+S

else

SLIV=14·(14−L+1)+(14−1−S)

where 0<L≤14−S

This encoding is based on the principle described in [4].

Each row of a TDRA table may thus refer to a SLIV value, rather than to separate S and L values. This can be particularly beneficial when configuring a communications device with a TDRA table, because it can be more efficient to signal the SLIV values for each row than to signal separate S and L values.

### Decoding SLIV Values

Various techniques are known for decoding SLIV values (that is, recovering the values of S and L used to calculate the SLIV value). For example, a look-up table can be used, where each possible SLIV value is associated with the corresponding S and L values.

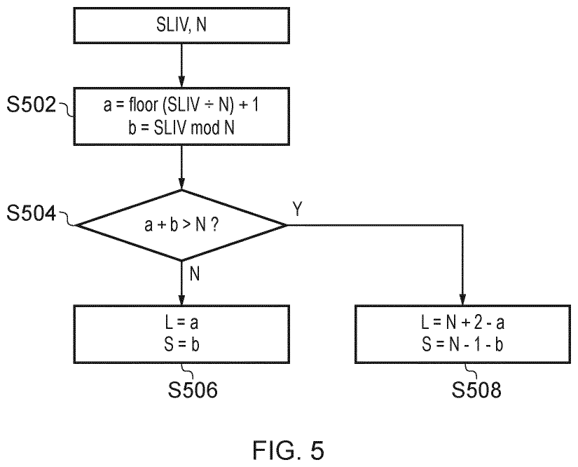

A more efficient method (which avoids the need to store the complete look-up table) is described in [4] and illustrated in FIG. 5

First, at step S502, calculate a and b as follows:

a=floor (SLIV÷N)+1

b=SLIV mod N

where floor(x) is equal to the greatest integer less than or equal to x, and mod is the modulo function, where x mod y is the remainder when x is divided by y, x mod y<y. In an example, N=14.

Then at step S504, determine if a+b>N. If it is, then control passes to step S508 and L and S are determined as:

L=N+2−a

S=N−1−b

If at step S504, it is determined that a+b≤N (i.e. ‘N’ branch), then control passes to step S506, and L and S are determined as:

L=a

S=b.

### Flexible Resource Allocation

It is proposed that, to increase the flexibility of allocation of uplink resources, it be permitted to allocate an instance of uplink communications resources which span multiple (e.g., two) time slots.

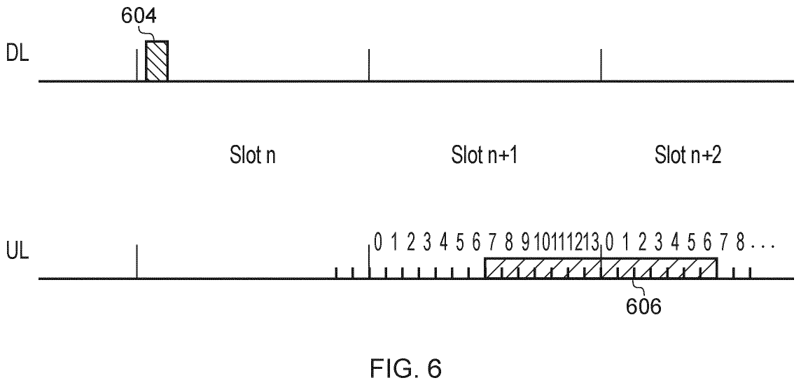

FIG. 6 shows an example of an allocation of uplink communications resources , by means of a DCI 606, in which the resources 608 comprise resources within slots n+1 and n+2, according to proposals for more flexible uplink resource allocations.

In the illustrated example, the communications resources start at the beginning of symbol 7 of slot n+1, and span 14 symbol periods. Accordingly, S=7 and L=14.

Values of L and S which correspond to allocations comprising resources in consecutive slots do not comply with the constraint that their sum be limited to no greater than 14. For example, the sum of S and L in the example of FIG. 6 is 21. Thus, in accordance with present proposals for more flexible resource allocations, weaker constraints may be applied to S and L. For example, it may be permitted to allocate resources provided only that the constraints L≤14 and S≤13 are satisfied.

It has been recognised that the conventional encoding technique yields ambiguous values for SLIV in such circumstances.

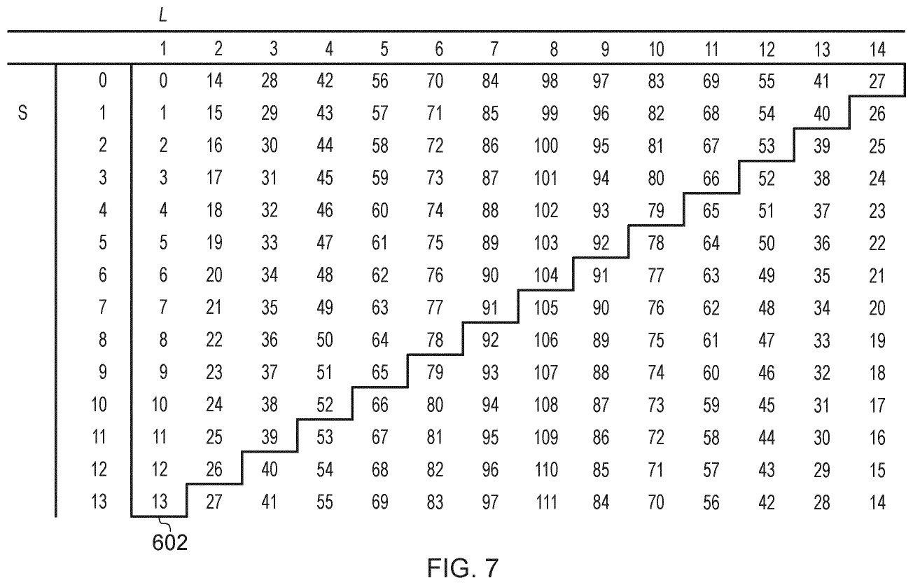

FIG. 7 shows a table of SLIV values for different S and L values, when calculated in accordance in the conventional manner described above.

Values which are above and to the left of the line 602 correspond to S and L combinations which satisfy the conventional requirement L+S≤N, where N is the number of symbol periods in a time slot and is equal to 14. Other values (i.e. those below and to the right of the line 602) may be permitted according to proposals for greater flexibility.

It will be observed that certain SLIV values appear twice within the table. For example, SLIV=27 for L=2, S=13 and for L=14, S=0. A receiver of an indication of such a SLIV value cannot, absent the conventional joint constraint on L and S, determine which are the correct (i.e. intended) values of S and L.

It has been suggested that an additional indication be included in the DCI message, to enable the communications device to determine the values of L and S. The determination would be based on the SLIV value corresponding to the TDRA table entry indicated in the DCI.

However, according to such a technique, additional signalling would be required in the DCI. Furthermore, this may limit the flexibility of the S and L combinations that could be indicated by the TDRA table to pairs associated with the same SLIV value.

There is thus a need to provide an efficient means for indicating S and L values corresponding to allocations of uplink communications resources which are not constrained to be (but may be) contained within a single slot.

Embodiments of the present technique provide a method of operating a communications device in a wireless communications network, the wireless communications network comprising infrastructure equipment providing a wireless access interface, the method comprising: receiving a downlink control information (DCI) message, the DCI message comprising a time domain indication of a start time and a duration of communications resources of the wireless access interface allocated for the transmission of data, the wireless access interface providing communications resources arranged in the time domain in time slots and symbol periods, each time slot comprising a plurality of symbol periods, and determining the start time and the duration of the allocated communications resources based on the time domain indication, wherein the time domain indication comprises an indication of the value of each of one or more parameters, the one or more parameters comprising a combined start and length indicator value (SLIV) calculated based on a symbol period number and a duration, and a slot offset, when the allocated communications resources are within a single time slot, the SLIV value is calculated based on the symbol period number and the duration in accordance with a first rule, when the allocated communications resources are not within a single time slot, the SLIV value is calculated based on the symbol period number and the duration in accordance with a second rule, and determining the start time comprises determining the symbol period number indicated by the SLIV value calculated using either the first rule or the second rule and the slot offset value.

In accordance with embodiments of the present technique, an infrastructure equipment can allocate, for a communications device, communications resources which span more than one slot. A method of encoding and decoding parameters for specifying a start time and a duration of the allocated resources is provided, which requires minimal additional signalling and permits re-use of techniques used to encode corresponding parameters for allocations which do not comprise resources in more than one timeslot.

In embodiments of the present technique, the SLIV is calculated based on L and S in a manner such that the resulting SLIV value is not ambiguous.

In some embodiments, the SLIV is calculated in accordance with a first rule when a constraint that the allocated communications resources do not comprise resources of more than one slot, and in accordance with a second rule when the constraint is not satisfied.

In some embodiments, the SLIV is calculated based on L and S in accordance with a first rule when a constraint on L and S is satisfied, and in accordance with a second rule when the constraint is not satisfied. In some embodiments, the constraint is that L and S are such that the allocated communications resources do not comprise resources of more than one slot.

In some embodiments, the first rule corresponds to a conventional rule applied when the constraint is required to be satisfied. For example, in some embodiments, the first rule corresponds to equation (1) above, which may be applicable to communications devices which do not support an allocation of communications resources which span two (or more) slots.

In some embodiments, the calculation for the first rule and the second rule is the same, and comprises the application of an offset C. In some embodiments, C is a first value when the first rule is applied and is a second value when the second rule is applied. In some embodiments, the first value is zero.

In some embodiments, no offset is applied in accordance with the first rule.

In some embodiments, according to the second rule, the offset C is applied to a value calculated according to the first rule, the offset being sufficient to ensure that no two valid combinations of S and L values result in a same SLIV value. For example, in some embodiments, the largest SLIV value that can be calculated using a valid combination of S and L values satisfying the constraint that S+L≤N is 104 (when N=14, S=6 and L=8). Accordingly, in some embodiments, the offset C is at least 105.

In some embodiments, the offset value C is no smaller than the largest SLIV value that can be calculated using a valid combination of S and L values (without requiring that the constraint that S+L≤N is satisfied), using the conventional calculation (e.g. using equation (1)). Accordingly, in some embodiments, the offset C is at least 112, because the highest SLIV value (when L=8 and S=13) is 111. That is, in some embodiments, the offset is when calculated according to the first rule for all permitted resource allocations.

In some embodiments, the offset is 128, to minimize the complexity of the operations of addition, subtraction, and modulo of the offset.

In some embodiments, the offset is such that no duplicate values of SLIV occur for any permitted combination of L and S. For example, referring to FIG. 7, the lowest value (without offset) that can occur in the lower right portion (i.e. below and to the right of the line 602) is 14, and the highest value that can occur in the upper left portion (i.e. above and to the left of the line 602) is 104. In this example, any offset of 91 or greater will satisfy this requirement. For example, in some embodiments, the offset is 104.

Preferably, the offset is predetermined and known to the receiver of an indication of a SLIV value. In some embodiments, the offset is specified in an appropriate standards document. In some embodiments, the offset may be indicated to the communications device, for example as part of an RRC reconfiguration.

In some embodiments, the SLIV when calculated in accordance with the presently described technique is indicated as a binary value represented by a number of bits. Preferably, the number of bits is one greater than the number of bits that can be used to represent the SLIV when calculated accordingly to conventional techniques (such as when the constraint is satisfied). Thus, embodiments can provide for techniques for indicating a symbol period number and duration using only one additional bit, while providing significantly greater flexibility in possible resource allocations.

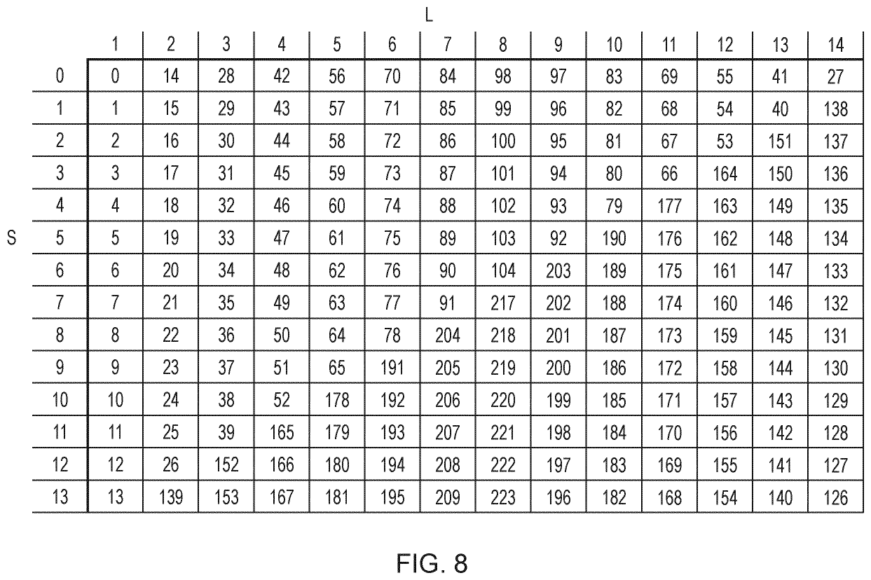

FIG. 8 shows a table of SLIV values for different S and L values, when calculated in accordance with embodiments of the present technique, in which the offset is 112. Specifically, where a joint constraint on S and L is satisfied, SLIV is calculated in accordance with equation (1) above. The joint constraint may correspond to a restriction that allocated communications resources must be within a single slot. Where the joint constraint is not satisfied, SLIV is calculated in accordance with equation (2) below (for the case where N=14).

if (L−1)≤7 then (2)

SLIV=14·(L−1)+S+C

else

SLIV=14·(14−L+1)+(14−1−S)+C

where C is the offset (and in the example of FIG. 8 is equal to 112).

As can be seen from FIG. 8, embodiments of the present technique can avoid any ambiguity in encoding or decoding an SLIV value, when there is no joint constraint on the values of S and L, requiring only that L≤14 and S≤13. For example, SLIV =27 indicates unambiguously L=14, S=0, and SLIV=139 indicates unambiguously L=2, S=13.

Embodiments of the present technique provide methods by which a receiver of a SLIV value calculated according to embodiments of the present technique can recover the S and L values.

In some embodiments, a look-up table providing, for each possible value of SLIV, the corresponding S and L values is stored and used to recover the S and L values based on a received SLIV value.

In some embodiments, S and L values are recovered by the sequence of:
a) determining whether an offset had been applied, based on whether the SLIV value is greater than or equal to the offset;
   b) if it had, reversing the application of the offset (e.g. by subtracting the offset from the SLIV value); and
   c) applying either a first recovery rule or a second recovery rule depending on the outcome of the determination at step a).

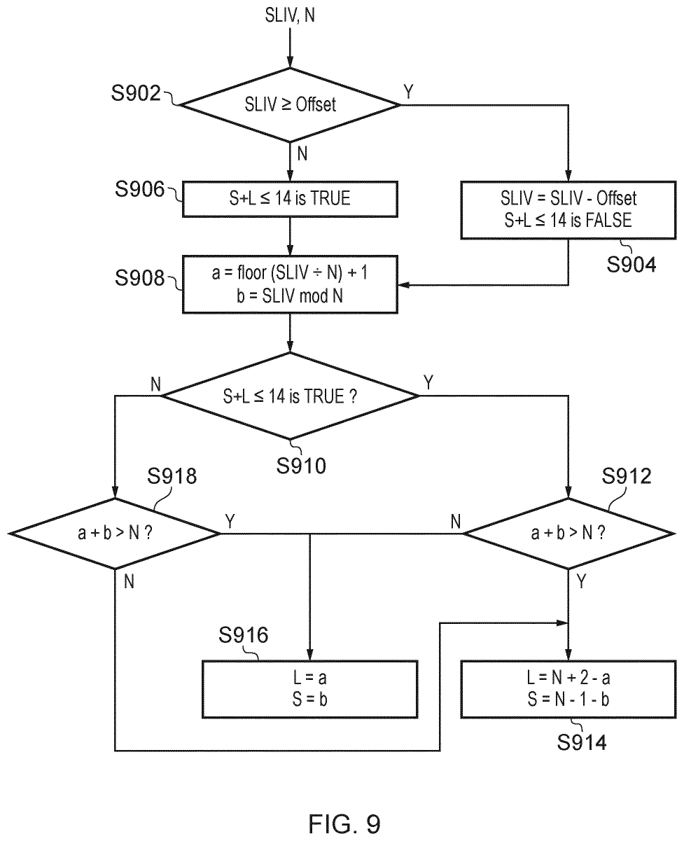

In some embodiments, a modification of the process illustrated in FIG. 5 is used. An example of the modified process is illustrated in FIG. 9.

The process starts with step S902 in which it is determined whether the SLIV value exceeds (or is equal to) the offset C. If it is (Y), then control passes to step S904. At step S904, the application of the offset is reversed and it is determined that the assertion S+L≤N is false (i.e. the joint constraint on S and L is not satisfied, indicating that the allocated resources comprise resources in more than one slot). Control then passes to step S908.

For example, in some embodiments, the application of the offset is reversed by subtracting the offset from the SLIV value (i.e. SLIV=SLIV−C).

In some embodiments, the application of the offset is reversed in step S904 by calculating:

$$SLIV = Received\_SLIV \_Value mod C + ( floor ( \frac{Received\_SLIV \_value}{C} ) - 1 ) * C$$

In some embodiments in which the offset C is such that 0≤SLIV<2×C for all possible SLIV values, the conditional modification to the SLIV value in step S904 based on the determination at step S902 may be replaced by a single modulo operation, i.e. SLIV=SLIV mod C,. The modulo operation may be applied irrespective of the outcome of the determination at step S902, since if the SLIV value does not exceed or equal the value of the offset C, then the modulo operation has no effect.

If at step S902 it is determined that the SLIV value is less than the offset C, then control passes to step S906. At step S906, it is determined that the assertion S+L≤N is true (i.e. the joint constraint on S and L is satisfied, indicating that the allocated resources comprise resources in only one slot). Control then passes to step S908.

S908 is the same as step S502 described earlier. After step S908, the process then continues with step

S910, in which it is determined whether S+L is less than or equal to N, based on the determination at steps S902, S904 and S906. If it is (“Y”, i.e. S+L≤N is true), the control passes to step S912. Steps S912, S916 and S914 are the same as step S504, S506 and S508, respectively, of the process shown in FIG. 5.

If at step S910 it is determined that S+L is not less than or equal to N (i.e. S+L≤N is false), then control passes to step S918. At step S918, it is determined if a+b>N. If it is, then control passes to step S916. If it is not, then control passes to step S914.

Accordingly, embodiments of the present technique can provide a method of decoding a SLIV value, calculated on the basis of S and L values which are not jointly constrained in a manner associated with a restriction on a resource allocation being contained within a single slot. The method can re-use many features of a conventional decoding process. Thus, development required to implement the new functionality is reduced, and re-use of existing functionality is possible. For example, in some embodiments, the receiver may know a priori that the resource allocation is contained within a single slot (for example, because the infrastructure equipment operates according to conventional techniques). The receiver may use an appropriate subset of steps of the process of FIG. 9 (such as steps S908, S912, S916 and S914) to calculate the S and L values given the a priori knowledge.

An example of a portion of a TDRA table which may be configured in accordance with embodiments of the present technique is shown as Table 1 for an offset value of 112. It will be appreciated that the TDRA table may indicate other parameters, and is not limited to 3 rows.

TABLE 1
Example TDRA table

| TDRA index | K2 | SLIV |
|---|---|---|
| 0 | 3 | 70 |
| 1 | 1 | 132 |
| 2 | 1 | 7 |

Referring to FIG. 8, or by performing the decoding process illustrated in FIG. 9 and described above, a receiver of an allocation which references a row of the TDRA table can determine the start time and duration of the allocation.

For example, if an indication of an allocation is received in slot n, referring to TDRA index 1, then, based on the SLIV value of 132, the receiver can determine that the S and L values are 7 and 14, respectively. Based on the K2 value, the receiver determines that the resources start in slot n+1. Taken in combination, the receiver determines that the resource allocation starts at the beginning of symbol period 7 within the slot following the one in which the allocation was received, and has a duration of 14 symbol periods. Accordingly, given that each slot comprises 14 symbol periods (i.e. N=14), the receiver determines that the allocated communications resources end within the subsequent (n+2) slot.

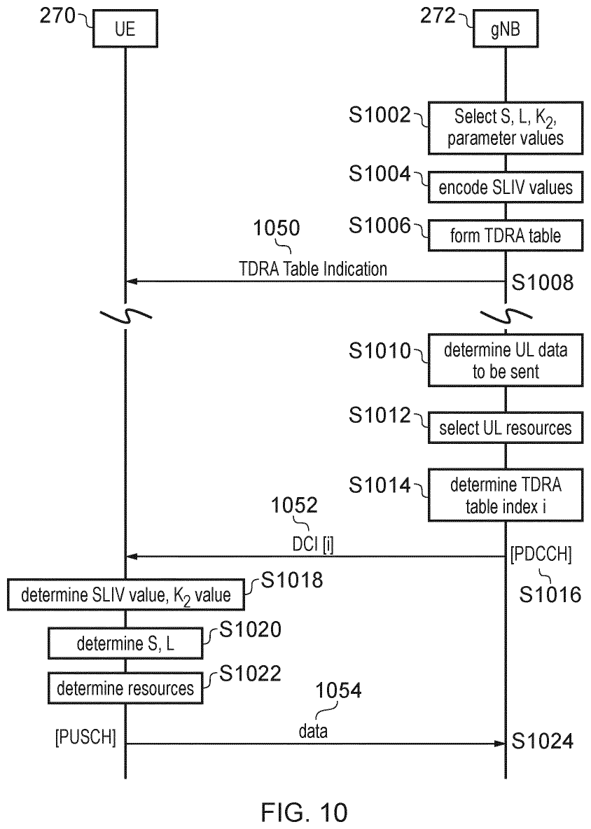

FIG. 10 is an example combined process diagram and message sequence chart illustrating embodiments of the present technique.

FIG. 10 shows the infrastructure equipment 272, which may correspond to a base station 101 of FIG. 1, or one or more of a TRP 211, 212 and a controlling node (CU) 221, 222 of FIG. 2. FIG. 10 also shows the communications device 270.

At the start of the process of FIG. 10, the communications device 270 is located within a cell controlled by the infrastructure equipment 272, and has established communications with the infrastructure equipment 272. For example, the communications device 270 may have completed, or be in the process of completing, an RRC connection establishment process.

At step S1002, the infrastructure equipment 272 selects a plurality of uplink resource allocation configurations for the communications device 270. Each configuration is associated with a set of parameter values, comprising a K2 parameter, an S parameter, and an L parameter. For example, the infrastructure equipment 272 may select up to 32 configurations. The configurations may be selected based on capabilities of the communications device 270, a nature (e.g. quality of service requirements, quantity) of data traffic which is expected to be transmitted by the communications device 270, or on any other basis.

At step S1004, the infrastructure equipment 272 determines the SLIV values corresponding to the S and L parameter values selected at step S1002. The SLIV values may be calculated in accordance with equations (1) and (2) (depending on whether the constraint that S+L≤N is satisfied) described above, or determined based on a look-up table, or determined in any other suitable manner.

At step S1006, the infrastructure equipment 272 constructs the TDRA table, assigning a TDRA index to each set of parameter values.

At step S1008, the infrastructure equipment 272 transmits a TDRA table indication 1050 comprising a representation of the TDRA table to the communications device 270. The TDRA table indication 1050 may be transmitted within an RRC Reconfiguration message. The TDRA table indication 1050 may be sent together with an indication of the offset used to calculate the SLIV values at step S1004.

In response to receiving the TDRA table indication 1050, the communications device 270 stores a representation of the TDRA table.

Subsequently, at step S1010, the infrastructure equipment 272 determines that uplink communications resources are to be allocated to the communications device 270 for the transmission of uplink data by the communications device 270 to the infrastructure equipment 272. The determination may be in response to receiving a buffer status report (BSR), a scheduling request (SR) or any similar indication from the communications device 270 that it has data available to send (not shown in FIG. 10).

At step S1012, the infrastructure equipment 272 selects uplink communications resources for the transmission of the data. The selected uplink communications resources are consistent with one of the set of parameter values associated with a TDRA index of the TDRA table formed at step S1006. Accordingly, at step S1014, the infrastructure equipment 272 determines the TDRA index i applicable to the allocated uplink communications resources.

At step S1016, the infrastructure equipment 272 transmits a TDRA index indication 1052, indicating the TDRA index i, the to the communications device 270. The TDRA index indication 1052 may be transmitted within a DCI, using a physical downlink control channel (PDCCH).

At step S1018, the communications device 270 determines the SLIV and K2 parameter values associated with the TDRA index indicated by the TDRA index indication 1052, based on the TDRA table indication received at step 1050.

At step S1020 the communications device 270 determines the S and L parameters corresponding to the SLIV value associated with the indicated TDRA index. This may be by means of a look-up table, or by use of the process illustrated in FIG. 9, or in any other suitable way.

Accordingly, based on the S, L and K2 values associated with the indicated TDRA index the communications device 270 determines the start time and duration of the allocated communications resources at step S1022.

It will be appreciated that the communications device 270 may, at step S1022, determine further parameters relevant to the allocation, such as a required modulation and coding scheme, frequency domain parameters, reference signal parameters and the like. These may be determined broadly in accordance with conventional means, for example based on additional indicators transmitted within the DCI message at step S1016. The communications resources may be on a physical uplink shared channel (PUSCH).

At step S1024, the communications device 270 transmits data 1054 using the communications resources determined at step S1022 and the process ends.

Examples described above may be combined, and/or modified. For example, within the scope of the present disclosure, one or more of the processes described above may be modified by the re-ordering, modifying or omission of certain steps, and such processes may be combined in some embodiments.

For example, the infrastructure equipment 272 may be pre-configured with a set of SLIV values for uplink resource allocation configurations which are calculated in accordance with embodiments of the present technique, such that step S1004 may be omitted from the process of FIG. 10. Similarly, the infrastructure equipment 272 may be pre-configured with the TDRA table, such that step S1006 may be omitted from the process of FIG. 10.

In some embodiments, the communications device 270 may calculate and store the S and L values corresponding to one or more of the SLIV values indicated by the TDRA table indication 1050 in response to receiving the TDRA table indication 1050; that is, the communications device 270 may not wait until it receives a resource allocation before calculating the S and L values for one or more TDRA index values.

It will further be appreciated that some processes can be replaced by alternatives yielding the same result.

In some embodiments, the DCI comprises an indication of an index to a table (such as the TDRA table described above). In some embodiments, the DCI comprises an indication of the SLIV, the SLIV be calculated in accordance with the technique described herein.

The preceding examples have been described in relation to the allocation of communications resources for uplink transmissions. In some embodiments, the allocation is for downlink communications resources, i.e. communications resources allocated for the transmission of data from the infrastructure equipment 272 to the communications device 270. In some such embodiments, the communications resources may comprise resources of a physical downlink shared channel (PDSCH).

Thus although there is described a technique for allocating uplink (e.g. PUSCH) resources for uplink transmission, the present disclosure is not so limited, and the techniques may be applicable also for the allocation of downlink resources, i.e. allocating time resource for the PDSCH, if the PDSCH is allowed to cross slot boundary

Accordingly, embodiments of the present technique can provide a method of receiving data by a communications device in a wireless communications network, the wireless communications network comprising infrastructure equipment providing a wireless access interface, the method comprising receiving a downlink control information (DCI) message, the DCI message comprising a time domain indication of a start time and a duration of communications resources of a wireless access interface allocated for the transmission of data by the infrastructure equipment to the communications device, the wireless access interface providing communications resources arranged in the time domain in time slots and symbol periods, each time slot comprising a plurality of symbol periods, receiving the data using the allocated communications resources, the start time and the duration of the allocated communications resources determined based on the time domain indication, wherein the time domain indication comprises an indication of the value of each of one or more parameters, the one or more parameters comprising a combined start and length indicator value (SLIV) calculated based on a symbol period number and a duration, and a slot offset, when the allocated communications resources are within a single time slot, the SLIV value is calculated based on the symbol period number and the duration in accordance with a first rule, when the allocated communications resources are not within a single time slot, the SLIV value is calculated based on the symbol period number and the duration in accordance with a second rule, and determining the start time comprises determining the symbol period number indicated by the SLIV value calculated using either the first rule or the second rule and the slot offset value.

In the description above, the combined parameter SLIV is used to indicate a start time S and a duration L of communications resources of an OFDM wireless access interface in which durations and times can be expressed based on OFDM symbol periods. However, the present disclosure is not so limited, and the combined parameter may be used to represent other parameters. For example, the parameters may indicate a start and duration of resources in a wireless access resource in which resources may be divided in time and/or frequency.

Preferably, the parameters are in some instances jointly constrained, in particular such that their sum is limited to be no greater than a predetermined value and more preferably, where the predetermined value is equal to a maximum value of one of the parameters.

In the examples described herein, the predetermined value (N) characterising the joint constraint is the number of symbol periods within a timeslot, which in some embodiments is 14. However, the present disclosure is not so limited, and the predetermined value may be set or defined in any appropriate manner.

Thus there has been described a method of operating a communications device in a wireless communications network, the wireless communications network comprising infrastructure equipment providing a wireless access interface, the method comprising: receiving a downlink control information (DCI) message, the DCI message comprising a time domain indication of a start time and a duration of communications resources of the wireless access interface allocated for the transmission of data, the wireless access interface providing communications resources arranged in the time domain in time slots and symbol periods, each time slot comprising a plurality of symbol periods, and determining the start time and the duration of the allocated communications resources based on the time domain indication, wherein the time domain indication comprises an indication of the value of each of one or more parameters, the one or more parameters comprising a combined start and length indicator value (SLIV) calculated based on a symbol period number and a duration, and a slot offset, when the allocated communications resources are within a single time slot, the SLIV value is calculated based on the symbol period number and the duration in accordance with a first rule, when the allocated communications resources are not within a single time slot, the SLIV value is calculated based on the symbol period number and the duration in accordance with a second rule, and determining the start time comprises determining the symbol period number indicated by the SLIV value calculated using either the first rule or the second rule and the slot offset value.

There has also been described a method of operating an infrastructure equipment in a wireless communications network, the wireless communications network comprising the infrastructure equipment providing a wireless access interface, the method comprising: determining that communications resources are to be allocated for the transmission of data; selecting the communications resources of the wireless access interface allocated for the transmission of the data, the wireless access interface providing communications resources arranged in the time domain in time slots and symbol periods, each time slot comprising a plurality of symbol periods; and transmitting a downlink control information (DCI) message, the DCI message comprising a time domain indication of a start time and a duration of the allocated communications resources; wherein the time domain indication comprises an indication of the value of each of one or more parameters, the one or more parameters comprising a combined start and length indicator value (SLIV) calculated based on a symbol period number and a duration of the allocated communications resources, and a slot offset, the start time of the allocated communications resources being indicated by the symbol period number and the slot offset, when the allocated communications resources are within a single time slot, the SLIV value is calculated based on the symbol period number and the duration in accordance with a first rule, when the allocated communications resources are not within a single time slot, the SLIV value is calculated based on the symbol period number and the duration in accordance with a second rule, and determining the start time comprises determining the symbol period number indicated by the SLIV value calculated using either the first rule or the second rule and the slot offset value.

Corresponding communications devices, infrastructure equipment and methods therefore, and circuitry for a communications device and circuitry for infrastructure equipment have also been described.

It will be appreciated that while the present disclosure has in some respects focused on implementations in an LTE-based and/or 5G network for the sake of providing specific examples, the same principles can be applied to other wireless telecommunications systems. Thus, even though the terminology used herein is generally the same or similar to that of the LTE and 5G standards, the teachings are not limited to the present versions of LTE and 5G and could apply equally to any appropriate arrangement not based on LTE or 5G and/or compliant with any other future version of an LTE, 5G or other standard.

It may be noted various example approaches discussed herein may rely on information which is predetermined/predefined in the sense of being known by both the base station and the communications device. It will be appreciated such predetermined/predefined information may in general be established, for example, by definition in an operating standard for the wireless telecommunication system, or in previously exchanged signalling between the base station and communications devices, for example in system information signalling, or in association with radio resource control setup signalling, or in information stored in a SIM application. That is to say, the specific manner in which the relevant predefined information is established and shared between the various elements of the wireless telecommunications system is not of primary significance to the principles of operation described herein. It may further be noted various example approaches discussed herein rely on information which is exchanged/communicated between various elements of the wireless telecommunications system and it will be appreciated such communications may in general be made in accordance with conventional techniques, for example in terms of specific signalling protocols and the type of communication channel used, unless the context demands otherwise. That is to say, the specific manner in which the relevant information is exchanged between the various elements of the wireless telecommunications system is not of primary significance to the principles of operation described herein.

It will be appreciated that the principles described herein are not applicable only to certain types of communications device, but can be applied more generally in respect of any types of communications device, for example the approaches are not limited to URLLC/IIoT devices or other low latency communications devices, but can be applied more generally, for example in respect of any type of communications device operating with a wireless link to the communication network, or for peer-to-peer transmissions.

It will further be appreciated that the principles described herein are applicable not only to LTE-based or 5G/NR-based wireless telecommunications systems, but are applicable for any type of wireless telecommunications system that supports a dynamic scheduling of shared communications resources.

Further particular and preferred aspects of the present invention are set out in the accompanying independent and dependent claims. It will be appreciated that features of the dependent claims may be combined with features of the independent claims in combinations other than those explicitly set out in the claims.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, define, in part, the scope of the foregoing claim terminology such that no inventive subject matter is dedicated to the public.

Respective features of the present disclosure are defined by the following numbered paragraphs:

Paragraph 1. A method of operating a communications device in a wireless communications network, the wireless communications network comprising infrastructure equipment providing a wireless access interface, the method comprising: receiving a downlink control information (DCI) message, the DCI message comprising a time domain indication of a start time and a duration of communications resources of the wireless access interface allocated for the transmission of data, the wireless access interface providing communications resources arranged in the time domain in time slots and symbol periods, each time slot comprising a plurality of symbol periods, and determining the start time and the duration of the allocated communications resources based on the time domain indication, wherein the time domain indication comprises an indication of the value of each of one or more parameters, the one or more parameters comprising a combined start and length indicator value (SLIV) calculated based on a symbol period number and a duration, and a slot offset, when the allocated communications resources are within a single time slot, the SLIV value is calculated based on the symbol period number and the duration in accordance with a first rule, when the allocated communications resources are not within a single time slot, the SLIV value is calculated based on the symbol period number and the duration in accordance with a second rule, and determining the start time comprises determining the symbol period number indicated by the SLIV value calculated using either the first rule or the second rule and the slot offset value.

Paragraph 2. A method according to paragraph 1, wherein the communications resources are allocated for the transmission of data by the communications device, the method comprising transmitting the data using the allocated communications resources.

Paragraph 3. A method according to paragraph 1, wherein the communications resources are allocated for the transmission of data by the infrastructure equipment to the communications device, the method comprising receiving the data using the allocated communications resources.

Paragraph 4. A method according to any of paragraphs 1 to 3, wherein the lowest possible value of the SLIV value calculated according to the second rule is greater than values of the SLIV when calculated according to the first rule for all permitted resource allocations.

Paragraph 5. A method according to any of paragraphs 1 to 4, wherein according to the first rule, the SLIV value is calculated as the value of N×(L−1)+S if (L−1)≤(N/2) and N×(N−L+1)+(N−1−S) otherwise, where L is the duration in symbol periods, the start time is at the beginning of symbol period S, and N is the number of symbol periods within a time slot.

Paragraph 6. A method according to any of paragraphs 1 to 4, wherein according to the first and second rules, the SLIV value is calculated as the value of N×(L−1)+S+C if (L−1)≤(N/2) and N×(N−L+1)+(N−1−S)+C otherwise, where L is the duration in symbol periods, the start time is at the beginning of symbol period S, and N is the number of symbol periods within a time slot.

Paragraph 7. A method according to paragraph 6, wherein according to the first rule, C=0

Paragraph 8. A method according to any of paragraphs 1 to 7, wherein according to the second rule, the SLIV value is calculated based on a symbol period number and a duration by applying a predetermined offset value C to the SLIV value which is obtained according to the first rule based on the symbol period number and the duration.

Paragraph 9. A method according to any of paragraphs 6 to 8, wherein, for the purposes of the second rule, C is greater than the greatest possible value of the SLIV when calculated according to the first rule for all permitted resource allocations.

Paragraph 10. A method according to any of paragraphs 6 to 9, wherein N=14 and, for the purposes of the second rule, C=128

Paragraph 11. A method according to any of paragraphs 6 to 8, wherein, for the purposes of the second rule, C is greater than the greatest possible value of the SLIV when calculated according to the first rule for all permitted resource allocations where the allocated communications resources are within a single time slot.

Paragraph 12. A method according to paragraph 11, wherein N=14 and, for the purposes of the second rule, C=105.

Paragraph 13. A method according to any of paragraphs 6 to 8, wherein according to the second rule C is a predetermined value greater than or equal to 91.

Paragraph 14. A method according to any of paragraphs 1 to 13, the method comprising receiving an indication of a plurality of values of the one or more parameters and, for each of the plurality of values, a corresponding index value, wherein the time domain indication comprises one of the index values. Paragraph 15. A method according to any of paragraphs 1 to 14, wherein determining the symbol period number (S) and duration (L) indicated by the SLIV value comprises determining whether the SLIV value is greater than or equal to the offset, and if so, deducting the offset from the SLIV value, calculating a first parameter, a, as one plus a greatest integer less than or equal to the SLIV value divided by the number N of symbol periods within a time slot, calculating a second parameter, b, as the remainder when the SLIV is divided by N, determining if S+L is less than or equal to N and if a+b is greater than N, and if S+L is less than or equal to N and a+b is greater than N, or S+L is not less than or equal to N and a+b is not greater than N, determining that L=N+2−a and that S=N−1−b, else, determining that L=a and S=b.

Paragraph 16. A method of operating an infrastructure equipment in a wireless communications network, the wireless communications network comprising the infrastructure equipment providing a wireless access interface, the method comprising: determining that communications resources are to be allocated for the transmission of data; selecting the communications resources of the wireless access interface allocated for the transmission of the data, the wireless access interface providing communications resources arranged in the time domain in time slots and symbol periods, each time slot comprising a plurality of symbol periods; and transmitting a downlink control information (DCI) message, the DCI message comprising a time domain indication of a start time and a duration of the allocated communications resources; wherein the time domain indication comprises an indication of the value of each of one or more parameters, the one or more parameters comprising a combined start and length indicator value (SLIV) calculated based on a symbol period number and a duration of the allocated communications resources, and a slot offset, the start time of the allocated communications resources being indicated by the symbol period number and the slot offset, when the allocated communications resources are within a single time slot, the SLIV value is calculated based on the symbol period number and the duration in accordance with a first rule, when the allocated communications resources are not within a single time slot, the SLIV value is calculated based on the symbol period number and the duration in accordance with a second rule, and determining the start time comprises determining the symbol period number indicated by the SLIV value calculated using either the first rule or the second rule and the slot offset value.

Paragraph 17. A method according to paragraph 16, wherein the allocated communications resources are allocated for the transmission of the data by a communications device to the infrastructure equipment, the method comprising: receiving the data transmitted using the allocated communications resources.

Paragraph 18. A method according to paragraph 16, wherein the allocated communications resources are allocated for the transmission of the data by the infrastructure equipment to a communications device, the method comprising: transmitting the data transmitted using the allocated communications resources.

Paragraph 19. A method according to any of paragraphs 16 to 18, wherein the lowest possible value of the SLIV value calculated according to the second rule is greater than values of the SLIV when calculated according to the first rule for all permitted resource allocations.

Paragraph 20. A method according to any of paragraphs 16 to 19, wherein according to the first rule, the SLIV value is calculated as the value of N×(L−1)+S if (L−1)≤(N/2) and N×(N−L+1)+(N−1−S) otherwise, where L is the duration in symbol periods, the start time is at the beginning of symbol period S, and N is the number of symbol periods within a time slot.

Paragraph 21. A method according to any of paragraphs 16 to 19, wherein according to the first and second rules, the SLIV value is calculated as the value of N×(L−1)+S+C if (L−1)≤(N/2) and N×(N−L+1)+(N−1−S)+C otherwise, where L is the duration in symbol periods, the start time is at the beginning of symbol period S, and N is the number of symbol periods within a time slot.

Paragraph 22. A method according to paragraph 21, wherein according to the first rule, C=0

Paragraph 23. A method according to any of paragraphs 16 to 23, wherein according to the second rule, the SLIV value is calculated based on a symbol period number and a duration by applying a predetermined offset value C to the SLIV value which is obtained according to the first rule based on the symbol period number and the duration.

Paragraph 24. A method according to any of paragraphs 21 to 23, wherein, for the purposes of the second rule, C is greater than the greatest possible value of the SLIV when calculated according to the first rule for all permitted resource allocations.

Paragraph 25. A method according to any of paragraphs 21 to 24, wherein N =14 and, for the purposes of the second rule, C =128

Paragraph 26. A method according to any of paragraphs 21 to 23, wherein, for the purposes of the second rule, C is greater than the greatest possible value of the SLIV when calculated according to the first rule for all permitted resource allocations where the allocated communications resources are within a single time slot.

Paragraph 27. A method according to paragraph 26, wherein N=14 and, for the purposes of the second rule, C=105.

Paragraph 28. A method according to any of paragraphs 21 to 23, wherein according to the second rule C is a predetermined value greater than or equal to 91.

Paragraph 29. A method according to any of paragraphs 16 to 28, the method comprising transmitting an indication of a plurality of values of the one or more parameters and, for each of the plurality of values, a corresponding index value, wherein the time domain indication comprises one of the index values.

Paragraph 30. A communications device for operating in a wireless communications network, the communications device comprising a transmitter configured to transmit signals via a time divided wireless access interface provided by an infrastructure equipment of the wireless communications network, the wireless access interface providing communications resources arranged in the time domain in time slots and symbol periods, each time slot comprising a plurality of symbol periods a receiver configured to receive signals via the wireless access interface, and a controller configured to control the transmitter and the receiver so that the communications device is operable: to receive a downlink control information (DCI) message, the DCI message comprising a time domain indication of a start time and a duration of communications resources of the wireless access interface allocated for the transmission of data, and to determine the start time and the duration of the allocated communications resources based on the time domain indication, wherein the time domain indication comprises an indication of the value of each of one or more parameters, the one or more parameters comprising a combined start and length indicator value (SLIV) calculated based on a symbol period number and a duration, and a slot offset, when the allocated communications resources are within a single time slot, the SLIV value is calculated based on the symbol period number and the duration in accordance with a first rule, when the allocated communications resources are not within a single time slot, the SLIV value is calculated based on the symbol period number and the duration in accordance with a second rule, and determining the start time comprises determining the symbol period number indicated by the SLIV value calculated using either the first rule or the second rule and the slot offset value.

Paragraph 31. Circuitry for a communications device for operating in a wireless communications network, the circuitry comprising: transmitter circuitry configured to transmit signals via a time divided wireless access interface provided by an infrastructure equipment of the wireless communications network, the wireless access interface providing communications resources arranged in the time domain in time slots and symbol periods, each time slot comprising a plurality of symbol periods receiver circuitry configured to receive signals via the wireless access interface, and controller circuitry configured to control the transmitter circuitry and the receiver circuitry so that the communications device is operable: to receive a downlink control information (DCI) message, the DCI message comprising a time domain indication of a start time and a duration of communications resources of the wireless access interface allocated for the transmission of data, and to determine the start time and the duration of the allocated communications resources based on the time domain indication, wherein the time domain indication comprises an indication of the value of each of one or more parameters, the one or more parameters comprising a combined start and length indicator value (SLIV) calculated based on a symbol period number and a duration, and a slot offset, when the allocated communications resources are within a single time slot, the SLIV value is calculated based on the symbol period number and the duration in accordance with a first rule, when the allocated communications resources are not within a single time slot, the SLIV value is calculated based on the symbol period number and the duration in accordance with a second rule, and determining the start time comprises determining the symbol period number indicated by the SLIV value calculated using either the first rule or the second rule and the slot offset value.

Paragraph 32. Infrastructure equipment for use in a wireless communications network, the infrastructure equipment providing a time divided wireless access interface for communicating with a communications device, the infrastructure equipment comprising: a transmitter configured to transmit signals to the communications device via the wireless access interface, the wireless access interface providing communications resources arranged in the time domain in time slots and symbol periods, each time slot comprising a plurality of symbol periods, a receiver configured to receive signals from the communications device, and a controller configured to control the transmitter and the receiver so that the infrastructure equipment is operable: to determine that communications resources are to be allocated for the transmission of data; to select the communications resources of the wireless access interface allocated for the transmission of the data; and transmitting a downlink control information (DCI) message, the DCI message comprising a time domain indication of a start time and a duration of the allocated communications resources; wherein the time domain indication comprises an indication of the value of each of one or more parameters, the one or more parameters comprising a combined start and length indicator value (SLIV) calculated based on a symbol period number and a duration of the allocated communications resources, and a slot offset, the start time of the allocated communications resources being indicated by the symbol period number and the slot offset, when the allocated communications resources are within a single time slot, the SLIV value is calculated based on the symbol period number and the duration in accordance with a first rule, when the allocated communications resources are not within a single time slot, the SLIV value is calculated based on the symbol period number and the duration in accordance with a second rule, and determining the start time comprises determining the symbol period number indicated by the SLIV value calculated using either the first rule or the second rule and the slot offset value.

Paragraph 33. Circuitry for infrastructure equipment for use in a wireless communications network, the infrastructure equipment providing a time divided wireless access interface for communicating with a communications device, the circuitry comprising: transmitter circuitry configured to transmit signals to the communications device via the wireless access interface, the wireless access interface providing communications resources arranged in the time domain in time slots and symbol periods, each time slot comprising a plurality of symbol periods, receiver circuitry configured to receive signals from the communications device, and controller circuitry configured to control the transmitter circuitry and the receiver circuitry so that the infrastructure equipment is operable: to determine that communications resources are to be allocated for the transmission of data; to select the communications resources of the wireless access interface allocated for the transmission of the data; and transmitting a downlink control information (DCI) message, the DCI message comprising a time domain indication of a start time and a duration of the allocated communications resources; wherein the time domain indication comprises an indication of the value of each of one or more parameters, the one or more parameters comprising a combined start and length indicator value (SLIV) calculated based on a symbol period number and a duration of the allocated communications resources, and a slot offset, the start time of the allocated communications resources being indicated by the symbol period number and the slot offset, when the allocated communications resources are within a single time slot, the SLIV value is calculated based on the symbol period number and the duration in accordance with a first rule, when the allocated communications resources are not within a single time slot, the SLIV value is calculated based on the symbol period number and the duration in accordance with a second rule, and determining the start time comprises determining the symbol period number indicated by the SLIV value calculated using either the first rule or the second rule and the slot offset value.

Further particular and preferred aspects of the present invention are set out in the accompanying independent and dependent claims. It will be appreciated that features of the dependent claims may be combined with features of the independent claims in combinations other than those explicitly set out in the claims.

### REFERENCES

[1] RP-182090, “Revised SID: Study on NR Industrial Internet of Things (IoT),” 3GPP RAN#81.

[2] Holma H. and Toskala A, “LTE for UMTS OFDMA and SC-FDMA based radio access”, John Wiley and Sons, 2009

[3] 3GPP TS 38.321, “Medium Access Control (MAC) protocol specification (Rel-15)”, v15.3.0

[4] 3GPP Tdoc R1-070881, “Uplink Resource Allocation for E-UTRA,” NEC Group, NTT DoCoMo, RAN1#48

[5] RP-190727, “New WID: UE Power Saving in NR”, CATT, CAICT, 3GPP RAN#83

[6] 3GPP Tdoc R1-1907323 “Procedure for cross-slot scheduling technique”, Ericsson

[7] 3GPP Tdoc RP-182089, “New SID on Physical Layer Enhancements for NR Ultra-Reliable and Low Latency Communication (URLLC),” RAN#81.

[8] 3GPP TS 38.214 “NR; Physical layer procedures for data (Release 15)” V15.4.0

[9] 3GPP Tdoc R1-1910828, “PUSCH enhancements for NR URLLC,”LG Electronics

1. A method of operating a communications device in a wireless communications network, the wireless communications network comprising infrastructure equipment providing a wireless access interface, the method comprising:
receiving a downlink control information (DCI) message, the DCI message comprising a time domain indication of a start time and a duration of communications resources of the wireless access interface allocated for the transmission of data, the wireless access interface providing communications resources arranged in the time domain in time slots and symbol periods, each time slot comprising a plurality of symbol periods, and
determining the start time and the duration of the allocated communications resources based on the time domain indication,
wherein
the time domain indication comprises an indication of the value of each of one or more parameters, the one or more parameters comprising a combined start and length indicator value (SLIV) calculated based on a symbol period number and a duration, and a slot offset,
when the allocated communications resources are within a single time slot, the SLIV value is calculated based on the symbol period number and the duration in accordance with a first rule,
when the allocated communications resources are not within a single time slot, the SLIV value is calculated based on the symbol period number and the duration in accordance with a second rule, and
determining the start time comprises determining the symbol period number indicated by the SLIV value calculated using either the first rule or the second rule and the slot offset value.

2. A method according to claim 1, wherein the communications resources are allocated for the transmission of data by the communications device, the method comprising
transmitting the data using the allocated communications resources.

3. A method according to claim 1, wherein the communications resources are allocated for the transmission of data by the infrastructure equipment to the communications device, the method comprising
receiving the data using the allocated communications resources.

4. A method according to claim 1, wherein the lowest possible value of the SLIV value calculated according to the second rule is greater than values of the SLIV when calculated according to the first rule for all permitted resource allocations.

5. A method according to claim 1, wherein according to the first rule, the SLIV value is calculated as the value of N×(L−1)+S if (L−1)≤(N/2) and N×(N−L+1)+(N−1−S) otherwise, where L is the duration in symbol periods, the start time is at the beginning of symbol period S, and N is the number of symbol periods within a time slot.

6. A method according to claim 1, wherein according to the first and second rules, the SLIV value is calculated as the value of N×(L−1)+S+C if (L−1)≤(N/2) and N×(N−L+1)+(N−1−S)+C otherwise, where L is the duration in symbol periods, the start time is at the beginning of symbol period S, and N is the number of symbol periods within a time slot.

7. A method according to claim 6, wherein according to the first rule, C=0

8. A method according to claim 1, wherein according to the second rule, the SLIV value is calculated based on a symbol period number and a duration by applying a predetermined offset value C to the SLIV value which is obtained according to the first rule based on the symbol period number and the duration.

9. A method according to claim 6, wherein, for the purposes of the second rule, C is greater than the greatest possible value of the SLIV when calculated according to the first rule for all permitted resource allocations.

10. A method according to claim 6, wherein N=14 and, for the purposes of the second rule, C=128

11. A method according to claim 6, wherein, for the purposes of the second rule, C is greater than the greatest possible value of the SLIV when calculated according to the first rule for all permitted resource allocations where the allocated communications resources are within a single time slot.

12. A method according to claim 11, wherein N=14 and, for the purposes of the second rule, C=105.

13. A method according to claim 6, wherein according to the second rule C is a predetermined value greater than or equal to 91.

14. A method according to claim 1, the method comprising
receiving an indication of a plurality of values of the one or more parameters and, for each of the plurality of values, a corresponding index value, wherein
the time domain indication comprises one of the index values.

15. A method according to claim 1, wherein determining the symbol period number (S) and duration (L) indicated by the SLIV value comprises
determining whether the SLIV value is greater than or equal to the offset, and if so, deducting the offset from the SLIV value,
calculating a first parameter, a, as one plus a greatest integer less than or equal to the SLIV value divided by the number N of symbol periods within a time slot,
calculating a second parameter, b, as the remainder when the SLIV is divided by N,
determining if S+L is less than or equal to N and if a+b is greater than N, and if
S+L is less than or equal to N and a+b is greater than N, or
S+L is not less than or equal to N and a+b is not greater than N,
determining that L=N+2−a and that S=N−1−b, else,
determining that L=a and S=b.

16.-29. (canceled)

30. A communications device for operating in a wireless communications network, the communications device comprising
a transmitter configured to transmit signals via a time divided wireless access interface provided by an infrastructure equipment of the wireless communications network, the wireless access interface providing communications resources arranged in the time domain in time slots and symbol periods, each time slot comprising a plurality of symbol periods
a receiver configured to receive signals via the wireless access interface, and
a controller configured to control the transmitter and the receiver so that the communications device is operable:
to receive a downlink control information (DCI) message, the DCI message comprising a time domain indication of a start time and a duration of communications resources of the wireless access interface allocated for the transmission of data, and
to determine the start time and the duration of the allocated communications resources based on the time domain indication,
wherein
the time domain indication comprises an indication of the value of each of one or more parameters, the one or more parameters comprising a combined start and length indicator value (SLIV) calculated based on a symbol period number and a duration, and a slot offset,
when the allocated communications resources are within a single time slot, the SLIV value is calculated based on the symbol period number and the duration in accordance with a first rule,
when the allocated communications resources are not within a single time slot, the SLIV value is calculated based on the symbol period number and the duration in accordance with a second rule, and
determining the start time comprises determining the symbol period number indicated by the SLIV value calculated using either the first rule or the second rule and the slot offset value.

31. (canceled)

32. Infrastructure equipment for use in a wireless communications network, the infrastructure equipment providing a time divided wireless access interface for communicating with a communications device, the infrastructure equipment comprising:
a transmitter configured to transmit signals to the communications device via the wireless access interface, the wireless access interface providing communications resources arranged in the time domain in time slots and symbol periods, each time slot comprising a plurality of symbol periods,
a receiver configured to receive signals from the communications device, and
a controller configured to control the transmitter and the receiver so that the infrastructure equipment is operable:
to determine that communications resources are to be allocated for the transmission of data;
to select the communications resources of the wireless access interface allocated for the transmission of the data; and
transmitting a downlink control information (DCI) message, the DCI message comprising a time domain indication of a start time and a duration of the allocated communications resources;
wherein
the time domain indication comprises an indication of the value of each of one or more parameters, the one or more parameters comprising a combined start and length indicator value (SLIV) calculated based on a symbol period number and a duration of the allocated communications resources, and a slot offset, the start time of the allocated communications resources being indicated by the symbol period number and the slot offset,
when the allocated communications resources are within a single time slot, the SLIV value is calculated based on the symbol period number and the duration in accordance with a first rule,
when the allocated communications resources are not within a single time slot, the SLIV value is calculated based on the symbol period number and the duration in accordance with a second rule, and
determining the start time comprises determining the symbol period number indicated by the SLIV value calculated using either the first rule or the second rule and the slot offset value.

33. (canceled)
